(19) United States
(12) Patent Application Publication
(10) Pub. No.: US 2026/0160174 A1
(43) Pub. Date: Jun. 11, 2026

(54) SEAL RUNNER LOCKING STRUCTURE

(71) Applicant: RTX Corporation, Farmington, CT (US)

(72) Inventors: Josue M. Martinez Ramos, Mayaguez, PR (US); Miguel Fernandez-Garcia, Mayaguez, PR (US); Heriberto Rodriguez Muniz, Moca, PR (US); Daniel E. Rosen, Colchester, CT (US)

(21) Appl. No.: 18/970,267

(22) Filed: Dec. 5, 2024

(51) Int. Cl. F01D 11/00

(52) U.S. Cl. CPC F01D 11/003; F01D 5/026; F05D 2260/30

(57) ABSTRACT

A shaft assembly includes a shaft that will be rotating in use. The shaft receives a seal runner, and a locking nut. The seal runner has a portion secured within an inner peripheral bore of the shaft, and the locking nut is mounted on an outer peripheral surface of the shaft. The seal runner further has a flange axially beyond the shaft. A key washer has non-rotation structure for preventing rotation of the key washer relative to the locking nut. A retaining ring is mounted in a channel in the key washer, and extends into a groove in the seal runner. A gas turbine engine and a method are also disclosed.

### STATEMENT REGARDING FEDERALLY SPONSORED RESEARCH OR DEVELOPMENT

This invention was made with Government support under Contract N00019-21-G-0005; DO N00019-23-F-0019 awarded by the United States Navy. The Government has certain rights in this invention.

### FIELD OF THE INVENTION

This application relates to a locking structure, and method of locking for securely holding a seal runner to a shaft.

### BACKGROUND OF THE INVENTION

Shaft seals are utilized in many industrial applications. In one type of shaft, a seal runner is retained on the shaft, and provides a flange surface which a seal abuts. The seal is mounted in static structure, and the seal runner rotates against the seal.

As known, in many applications shafts are subject to vibration. This can cause the seal runner to become loose, and not securely connected to the shaft. This is undesirable.

One application for a shaft of the seal runner is in a gas turbine engine.

### SUMMARY OF THE INVENTION

In a featured embodiment, a shaft assembly includes a shaft that will be rotating in use. The shaft receives a seal runner, and a locking nut. The seal runner has a portion secured within an inner peripheral bore of the shaft, and the locking nut is mounted on an outer peripheral surface of the shaft. The seal runner further has a flange axially beyond the shaft. A key washer has non-rotation structure for preventing rotation of the key washer relative to the locking nut. A retaining ring is mounted in a channel in the key washer, and extends into a groove in the seal runner.

In another embodiment according to the previous embodiment, a seal is mounted in static structure, and contacts the flange.

In another embodiment according to any of the previous embodiments, the locking nut and the seal runner are threadably secured to the shaft.

In another embodiment according to any of the previous embodiments, the groove in the seal runner is formed in a plurality of circumferentially spaced tabs on an outer periphery of the seal runner flange.

In another embodiment according to any of the previous embodiments, the retaining ring has a plurality of ring slots to allow passage of the tabs on the seal runner when the retaining ring is mounted onto the seal runner, with the retaining ring then being turned such that the ring slots are no longer aligned with the seal runner tabs.

In another embodiment according to any of the previous embodiments, the groove in the seal runner is formed in a plurality of circumferentially spaced tabs on an outer periphery of the seal runner flange.

In another embodiment according to any of the previous embodiments, the retaining ring has at least one ring serration at an outer periphery, and the groove has key washer serrations such that the at least one retaining ring serration lock the retaining ring relative to the groove.

In another embodiment according to any of the previous embodiments, the retaining ring has a plurality of ring slots to allow passage of the tabs on the seal runner when the retaining ring is mounted onto the seal runner, with the retaining ring then being turned such that the ring slots are no longer aligned with the seal runner tabs.

In another featured embodiment, a gas turbine engine includes a turbine section, a compressor section, and a combustor. There is a shaft assembly in the gas turbine engine. The shaft assembly has a shaft that will be rotating in use. The shaft receives a seal runner, and a locking nut. The seal runner has a portion within an inner peripheral bore of the shaft, and the locking nut is mounted on an outer peripheral surface of the shaft. The seal runner further has a flange axially beyond the shaft. A seal is mounted in static structure, and contacts the flange. A key washer has non-rotation structure for preventing rotation of the key washer relative to the locking nut. A retaining ring is mounted in a channel in the key washer, and extends into a groove in the seal runner.

In another embodiment according to any of the previous embodiments, the locking nut and the seal runner are threadably secured to the shaft.

In another embodiment according to any of the previous embodiments, the groove in the seal runner is formed on a plurality of circumferentially spaced tabs on an outer periphery of the seal runner flange.

In another embodiment according to any of the previous embodiments, the retaining ring has a plurality of ring slots to allow passage of the tabs on the seal runner when the retaining ring is mounted onto the seal runner, with the retaining ring then being turned such that the ring slots are no longer aligned with the seal runner tabs.

In another embodiment according to any of the previous embodiments, the groove in the seal runner is formed on a plurality of circumferentially spaced tabs on an outer periphery of the seal runner flange.

In another embodiment according to any of the previous embodiments, the retaining ring has at least one ring serration at an outer periphery, and the groove has key washer serrations such that the at least one retaining ring serration lock the retaining ring relative to the groove.

In another embodiment according to any of the previous embodiments, the retaining ring has a plurality of ring slots to allow passage of the tabs on the seal runner when the retaining ring is mounted onto the seal runner, with the retaining ring then being turned such that the ring slots are no longer aligned with the seal runner tabs.

In another featured embodiment, a method of assembling a seal runner to a rotating shaft includes the steps of providing a shaft, and mounting a locking nut to an outer peripheral surface on the shaft. A seal runner is mounted at an inner peripheral surface of the shaft to form an initial assembly. The seal runner has a flange axially beyond the shaft for providing a sealing surface with a seal assembly. A retaining ring is mounted within a key washer, and moves a subassembly of the key washer and retaining ring onto the initial assembly, with anti-rotation structure formed to prevent rotation of the key washer relative to the locking nut, and with slots in both the key washer and the retaining ring allowing passage of seal runner tabs on the seal runner to pass. The retaining ring is then turned such that the ring slots are no longer aligned with the seal runner tabs and such that the seal runner is retained.

In another embodiment according to any of the previous embodiments, the locking nut and the seal runner are threadably secured to the shaft.

In another embodiment according to any of the previous embodiments, seal runner grooves are formed at a plurality of circumferentially spaced tabs on an outer periphery of the seal runner flange.

In another embodiment according to any of the previous embodiments, the retaining ring has at least one ring serration, and there is a plurality of key washer serrations in the key washer. The step of turning the retaining ring has the at least one retaining ring serration moving along the plurality of key washer serrations to lock the retaining ring.

In another embodiment according to any of the previous embodiments, the retaining ring has spaced ends that are brought together to mount the retaining ring to the key washer.

The present disclosure may include any one or more of the individual features disclosed above and/or below alone or in any combination thereof.

These and other features of the present invention can be best understood from the following specification and drawings, the following of which is a brief description.

### BRIEF DESCRIPTION OF THE DRAWINGS

FIG. 1 schematically shows a gas turbine engine.

FIG. 2A shows an assembly for securing a seal runner to a shaft, and along line A-A of FIG. 2B.

FIG. 2B is a front view of the FIG. 2A structure.

FIG. 3 is an exploded view of the assembly of FIG. 2A.

FIG. 4A is a first step in assembling locking structure for holding a seal runner in the FIG. 2A assembly.

FIG. 4B shows a subsequent step.

FIG. 4C shows yet another subsequent step.

FIG. 4D shows yet another subsequent step.

FIG. 5 shows a final step.

### DETAILED DESCRIPTION

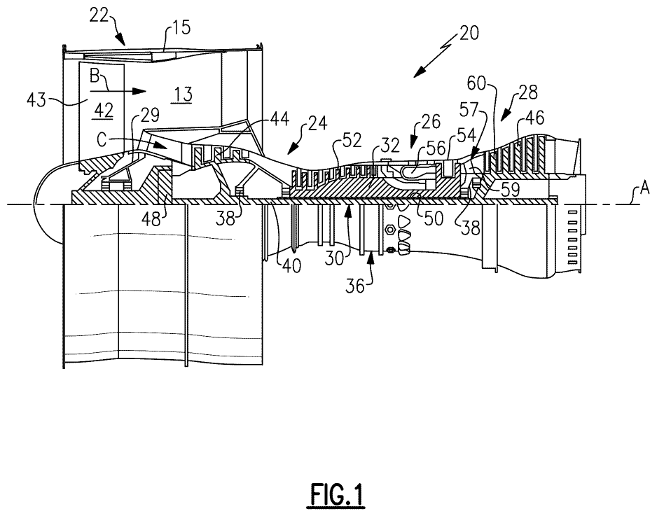

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. The fan section 22 may include a single-stage fan 42 having a plurality of fan blades 43. The fan blades 43 may have a fixed stagger angle or may have a variable pitch to direct incoming airflow from an engine inlet. The fan 42 drives air along a bypass flow path B in a bypass duct 13 defined within a housing 15 such as a fan case or nacelle, and also drives air along a core flow path C for compression and communication into the combustor section 26 then expansion through the turbine section 28. A splitter 29 aft of the fan 42 divides the air between the bypass flow path B and the core flow path C. The housing 15 may surround the fan 42 to establish an outer diameter of the bypass duct 13. The splitter 29 may establish an inner diameter of the bypass duct 13. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures. The engine 20 may incorporate a variable area nozzle for varying an exit area of the bypass flow path B and/or a thrust reverser for generating reverse thrust.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects, a first (or low) pressure compressor 44 and a first (or low) pressure turbine 46. The inner shaft 40 is connected to the fan 42 through a speed change mechanism, which in the exemplary gas turbine engine 20 is illustrated as a geared architecture 48 to drive the fan 42 at a lower speed than the low speed spool 30. The inner shaft 40 may interconnect the low pressure compressor 44 and low pressure turbine 46 such that the low pressure compressor 44 and low pressure turbine 46 are rotatable at a common speed and in a common direction. In other embodiments, the low pressure turbine 46 drives both the fan 42 and low pressure compressor 44 through the geared architecture 48 such that the fan 42 and low pressure compressor 44 are rotatable at a common speed. Although this application discloses geared architecture 48, its teaching may benefit direct drive engines having no geared architecture. The high speed spool 32 includes an outer shaft 50 that interconnects a second (or high) pressure compressor 52 and a second (or high) pressure turbine 54. A combustor 56 is arranged in the exemplary gas turbine 20 between the high pressure compressor 52 and the high pressure turbine 54. A mid-turbine frame 57 of the engine static structure 36 may be arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

Airflow in the core flow path C is compressed by the low pressure compressor 44 then the high pressure compressor 52, mixed and burned with fuel in the combustor 56, then expanded through the high pressure turbine 54 and low pressure turbine 46. The mid-turbine frame 57 includes airfoils 59 which are in the core flow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of the low pressure compressor, or aft of the combustor section 26 or even aft of turbine section 28, and fan 42 may be positioned forward or aft of the location of gear system 48.

The fan 42 may have at least 10 fan blades 43 but no more than 20 or 24 fan blades 43. In examples, the fan 42 may have between 12 and 18 fan blades 43, such as 14 fan blades 43. An exemplary fan size measurement is a maximum radius between the tips of the fan blades 43 and the engine central longitudinal axis A. The maximum radius of the fan blades 43 can be at least 40 inches, or more narrowly no more than 75 inches. For example, the maximum radius of the fan blades 43 can be between 45 inches and 60 inches, such as between 50 inches and 55 inches. Another exemplary fan size measurement is a hub radius, which is defined as distance between a hub of the fan 42 at a location of the leading edges of the fan blades 43 and the engine central longitudinal axis A. The fan blades 43 may establish a fan hub-to-tip ratio, which is defined as a ratio of the hub radius divided by the maximum radius of the fan 42. The fan hub-to-tip ratio can be less than or equal to 0.35, or more narrowly greater than or equal to 0.20, such as between 0.25 and 0.30. The combination of fan blade counts and fan hub-to-tip ratios disclosed herein can provide the engine 20 with a relatively compact fan arrangement.

The low pressure compressor 44, high pressure compressor 52, high pressure turbine 54 and low pressure turbine 46 each include one or more stages having a row of rotatable airfoils. Each stage may include a row of vanes adjacent the rotatable airfoils. The rotatable airfoils are schematically indicated at 47, and the vanes are schematically indicated at 49.

The low pressure compressor 44 and low pressure turbine 46 can include an equal number of stages. For example, the engine 20 can include a three-stage low pressure compressor 44, an eight-stage high pressure compressor 52, a two-stage high pressure turbine 54, and a three-stage low pressure turbine 46 to provide a total of sixteen stages. In other examples, the low pressure compressor 44 includes a different (e.g., greater) number of stages than the low pressure turbine 46. For example, the engine 20 can include a five-stage low pressure compressor 44, a nine-stage high pressure compressor 52, a two-stage high pressure turbine 54, and a four-stage low pressure turbine 46 to provide a total of twenty stages. In other embodiments, the engine 20 includes a four-stage low pressure compressor 44, a nine-stage high pressure compressor 52, a two-stage high pressure turbine 54, and a three-stage low pressure turbine 46 to provide a total of eighteen stages. It should be understood that the engine 20 can incorporate other compressor and turbine stage counts, including any combination of stages disclosed herein.

The engine 20 may be a high-bypass geared aircraft engine. It should be understood that the teachings disclosed herein may be utilized with various engine architectures, such as low-bypass turbofan engines, prop fan and/or open rotor engines, turboprops, turbojets, etc. The bypass ratio can be greater than or equal to 10.0 and less than or equal to about 18.0, or more narrowly can be less than or equal to 16.0. The geared architecture 48 may be an epicyclic gear train, such as a planetary gear system or a star gear system. The epicyclic gear train may include a sun gear, a ring gear, a plurality of intermediate gears meshing with the sun gear and ring gear, and a carrier that supports the intermediate gears. The sun gear may provide an input to the gear train. The ring gear (e.g., star gear system) or carrier (e.g., planetary gear system) may provide an output of the gear train to drive the fan 42. A gear reduction ratio may be greater than or equal to 2.3, or more narrowly greater than or equal to 3.0, and in some embodiments the gear reduction ratio is greater than or equal to 3.4. The gear reduction ratio may be less than or equal to 4.0. The fan diameter is significantly larger than that of the low pressure compressor 44. The low pressure turbine 46 can have a pressure ratio that is greater than or equal to 8.0 and in some embodiments is greater than or equal to 10.0. The low pressure turbine pressure ratio can be less than or equal to 13.0, or more narrowly less than or equal to 12.0. Low pressure turbine 46 pressure ratio is pressure measured prior to an inlet of low pressure turbine 46 as related to the pressure at the outlet of the low pressure turbine 46 prior to an exhaust nozzle. It should be understood, however, that the above parameters are only exemplary of one embodiment of a geared architecture engine and that the present invention is applicable to other gas turbine engines including direct drive turbofans. All of these parameters are measured at the cruise condition described below.

A significant amount of thrust is provided by the bypass flow B due to the high bypass ratio. The fan section 22 of the engine 20 is designed for a particular flight condition—typically cruise at about 0.8 Mach and about 35,000 feet (10,668 meters). The flight condition of 0.8 Mach and 35,000 ft (10,668 meters), with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. The engine parameters described above, and those in the next paragraph are measured at this condition unless otherwise specified.

“Fan pressure ratio” is the pressure ratio across the fan blade 43 alone, without a Fan Exit Guide Vane (“FEGV”) system. A distance is established in a radial direction between the inner and outer diameters of the bypass duct 13 at an axial position corresponding to a leading edge of the splitter 29 relative to the engine central longitudinal axis A. The fan pressure ratio is a spanwise average of the pressure ratios measured across the fan blade 43 alone over radial positions corresponding to the distance. The fan pressure ratio can be less than or equal to 1.45, or more narrowly greater than or equal to 1.25, such as between 1.30 and 1.40. “Corrected fan tip speed” is the actual fan tip speed in ft/sec divided by an industry standard temperature correction of [(Tram ° R)/(518.7° R)]^{0.5}. The corrected fan tip speed can be less than or equal to 1150.0 ft/second (350.5 meters/second), and can be greater than or equal to 1000.0 ft/second (304.8 meters/second).

The fan 42, low pressure compressor 44 and high pressure compressor 52 can provide different amounts of compression of the incoming airflow that is delivered downstream to the turbine section 28 and cooperate to establish an overall pressure ratio (OPR). The OPR is a product of the fan pressure ratio across a root (i.e., 0% span) of the fan blade 43 alone, a pressure ratio across the low pressure compressor 44 and a pressure ratio across the high pressure compressor 52. The pressure ratio of the low pressure compressor 44 is measured as the pressure at the exit of the low pressure compressor 44 divided by the pressure at the inlet of the low pressure compressor 44. In examples, a sum of the pressure ratio of the low pressure compressor 44 and the fan pressure ratio is between 3.0 and 6.0, or more narrowly is between 4.0 and 5.5. The pressure ratio of the high pressure compressor ratio 52 is measured as the pressure at the exit of the high pressure compressor 52 divided by the pressure at the inlet of the high pressure compressor 52. In examples, the pressure ratio of the high pressure compressor 52 is between 9.0 and 12.0, or more narrowly is between 10.0 and 11.5. The OPR can be equal to or greater than 45.0, and can be less than or equal to 70.0, such as between 50.0 and 60.0. The overall and compressor pressure ratios disclosed herein are measured at the cruise condition described above, and can be utilized in two-spool architectures such as the engine 20 as well as three-spool engine architectures.

The engine 20 establishes a turbine entry temperature (TET). The TET is defined as a maximum temperature of combustion products communicated to an inlet of the turbine section 28 at a maximum takeoff (MTO) condition. The inlet is established at the leading edges of the axially forwardmost row of airfoils of the turbine section 28, and MTO is measured at maximum thrust of the engine 20 at static sea-level and 86 degrees Fahrenheit (° F.). The TET may be greater than or equal to 2700.0° F., or more narrowly less than or equal to 3500.0° F., such as between 2750.0° F. and 3350.0° F. The relatively high TET can be utilized in combination with the other techniques disclosed herein to provide a compact turbine arrangement.

The engine 20 establishes an exhaust gas temperature (EGT). The EGT is defined as a maximum temperature of combustion products in the core flow path C communicated to at the trailing edges of the axially aftmost row of airfoils of the turbine section 28 at the MTO condition. The EGT may be less than or equal to 1000.0° F., or more narrowly greater than or equal to 800.0° F., such as between 900.0° F. and 975.0° F. The relatively low EGT can be utilized in combination with the other techniques disclosed herein to reduce fuel consumption.

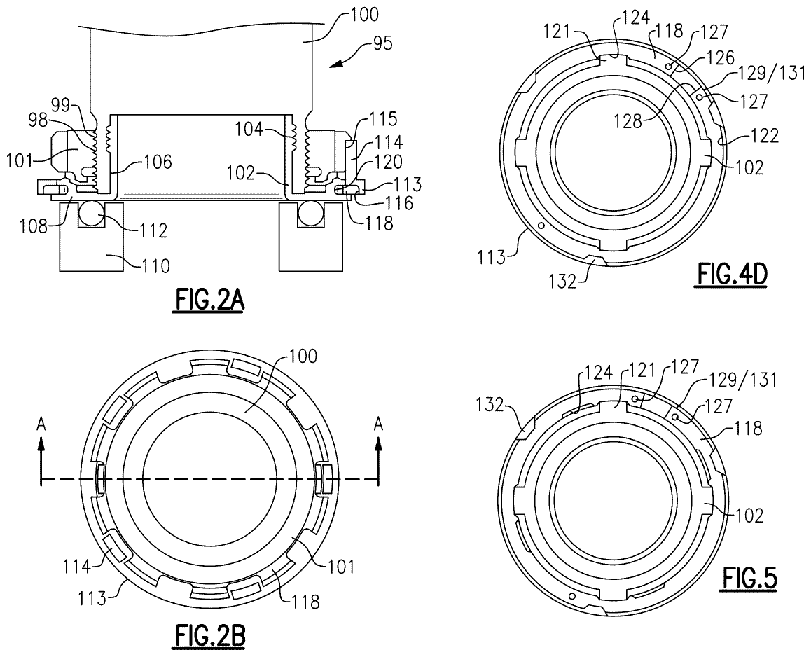

FIG. 2A shows an assembly 95 for securing a shaft 100 to a seal runner 102. As shown, there is a threaded connection 104 between the seal runner 102 and the shaft 100 at an inner peripheral surface 106 of the shaft 100. A locking spanner nut 101 is secured at an outer peripheral surface 98 of the shaft 100 on a threaded connection 99. The assembly may be in a gas turbine engine, such as described with regard to FIG. 1.

The seal runner 102 has an outwardly extending flange 108. Static structure 110 mounts a seal 112 in contact with the flange 108. The seal and structure 110/112 as illustrated here is a simplified view. It should be understood that the actual seal assembly might be much more complex.

A key washer 113 is mounted outwardly of the seal runner 102. Flanges 114 on the key washer 113 extend into slots 115 in an outer periphery of the locking nut 101. A retaining ring 118 is received in a groove 116 in the key washer 113. In addition, the seal runner has a groove 120 also receiving a portion of the retaining ring 118.

As shown in FIG. 2B, the shaft 100 is received inwardly of the spanner locking nut 101. The flanges 114 on the key washer 113 are received in slots 115 at an outer periphery of the spanner locking nut 101.

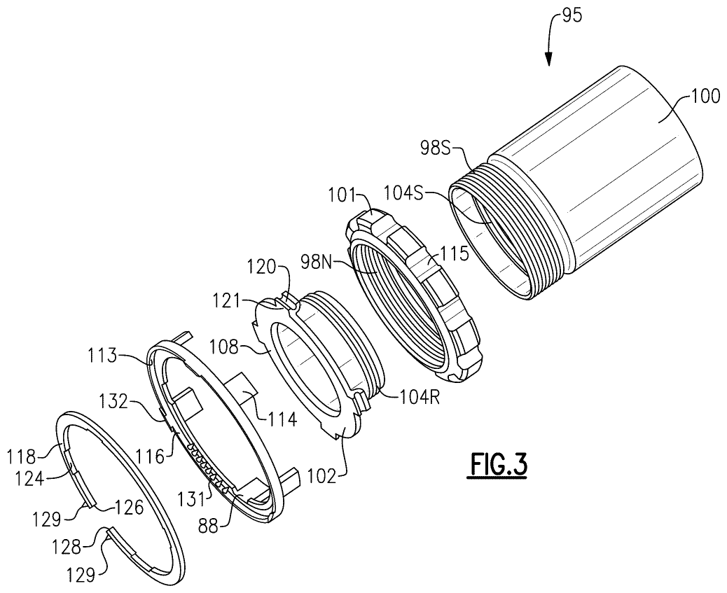

FIG. 3 is an exploded view of the assembly 95. As shown, shaft 100 has inner threads 104S and outer threads 98S.

The locking nut 101 has the slots 115 to receive the flanges 114, and inner threads 98N.

The seal runner 102 has outer threads 104R. The flange surface 108 has a plurality of tabs 121 each of which have a groove 120.

The key washer 113 has the groove 116, and the flanges 114. Slots 88 in the inner periphery of the key washer 113 which will allow passage of the tabs 121 from the seal runner.

The retaining ring 118 also has slots 124 that will allow passage of the tabs 121 from the seal runner 102. As also shown, the retaining ring 118 has ends 126 and 128 and is not fully cylindrical.

At least one serrated tooth 129 is formed on an outer periphery of the retaining ring 118. Mating serrations 131 are formed in the groove 116 of key washer 113.

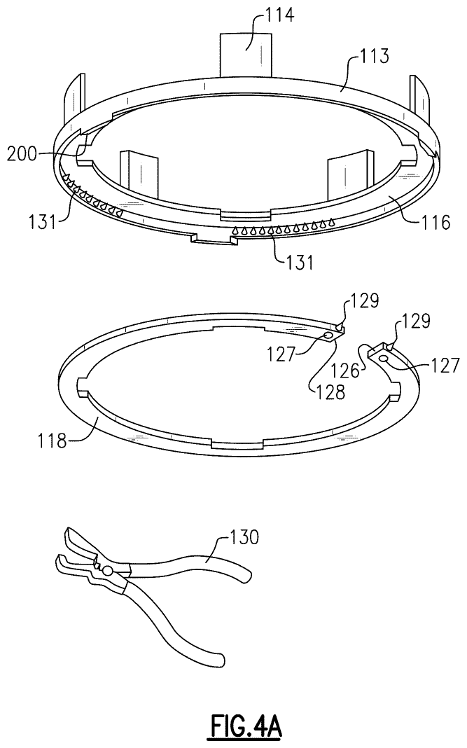

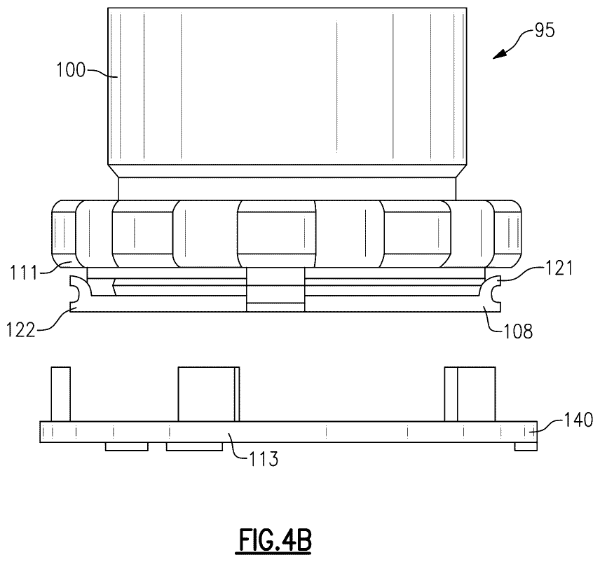

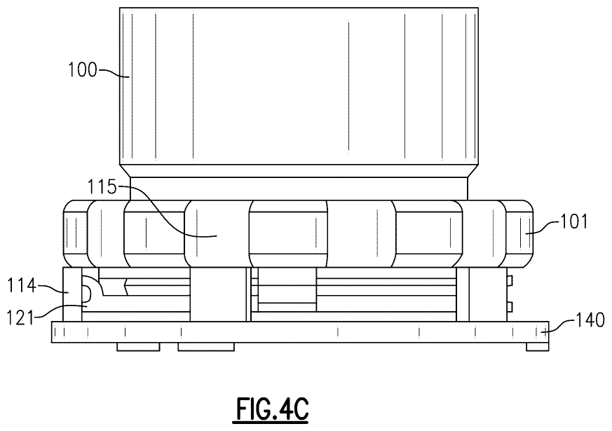

A method of assembling the assembly 95 is shown across FIGS. 4A-4D and 5. Initially, the locking nut 101 and seal runner 102 are mounted on the shaft 100. A plier 130 or other tool grabs holes 127 adjacent the ends 126/128 of the retaining ring 118, and moves them towards each other such that the retaining ring can move past outer retaining structure 132 outward of the groove 116 on the key washer 113.

Then, as shown in FIG. 4B, a subassembly 140 of key washer 113 and retaining ring 118 is moved toward the remainder of the assembly 95.

As shown in FIG. 4C, the flanges 114 are aligned with slots 115. When this step is occurring, the tabs 121 on the seal runner 102 are aligned with the slots 88 in the key washer, and the slots 124 in the retaining ring.

As shown in FIG. 4D, the tabs 121 are aligned with the slots 124.

The end surfaces 132 hold the retaining ring 118.

As shown in FIG. 5, the retaining ring 118 is now turned such that the slots 124 are no longer aligned with the tabs 121.

Although the serrations 129 and 131 are not illustrated in these views, this is because they are relatively small. There size has been somewhat exaggerated in FIGS. 3 and 4A to illustrate the fact of them.

The serrations also serve to lock the retaining ring 118 on key washer 113. The combination of the serrations 129 and 131, along with the fact that grooves 124 are no longer aligned with tabs 120, locks seal runner 102 to the locking nut 110.

Although embodiments have been disclosed, a worker of ordinary skill in this art would recognize that modifications would come within the scope of this disclosure. For that reason, the following claims should be studied to determine the true scope and content of this disclosure.

What is claimed is:

1. A shaft assembly comprising:
a shaft that will be rotating in use, said shaft receiving a seal runner, and a locking nut;
the seal runner having a portion secured within an inner peripheral bore of the shaft, and the locking nut mounted on an outer peripheral surface of the shaft, the seal runner further having a flange axially beyond the shaft;
a key washer having non-rotation structure for preventing rotation of the key washer relative to the locking nut;
a retaining ring mounted in a channel in the key washer, and extending into a groove in the seal runner.

2. The shaft assembly as set forth in claim 1, wherein a seal is mounted in static structure, and contacts said flange.

3. The shaft assembly as set forth in claim 1, wherein the locking nut and the seal runner are threadably secured to the shaft.

4. The shaft assembly as set forth in claim 3, wherein the groove in the seal runner is formed in a plurality of circumferentially spaced tabs on an outer periphery of the seal runner flange.

5. The shaft assembly as set forth in claim 4, wherein the retaining ring has a plurality of ring slots to allow passage of the tabs on the seal runner when the retaining ring is mounted onto the seal runner, with the retaining ring then being turned such that the ring slots are no longer aligned with the seal runner tabs.

6. The shaft assembly as set forth in claim 1, wherein the groove in the seal runner is formed in a plurality of circumferentially spaced tabs on an outer periphery of the seal runner flange.

7. The shaft assembly as set forth in claim 1, wherein the retaining ring has at least one ring serration at an outer periphery, and the groove having key washer serrations such that the at least one retaining ring serration lock the retaining ring relative to the groove.

8. The shaft assembly as set forth in claim 1, wherein the retaining ring has a plurality of ring slots to allow passage of the tabs on the seal runner when the retaining ring is mounted onto the seal runner, with the retaining ring then being turned such that the ring slots are no longer aligned with the seal runner tabs.

9. A gas turbine engine comprising:
a turbine section, a compressor section, and a combustor;
there being a shaft assembly in the gas turbine engine;
the shaft assembly having a shaft that will be rotating in use, said shaft receiving a seal runner, and a locking nut;
the seal runner having a portion within an inner peripheral bore of the shaft, and the locking nut mounted on an outer peripheral surface of the shaft, the seal runner further having a flange axially beyond the shaft;
a seal is mounted in static structure, and contacts said flange;
a key washer having non-rotation structure for preventing rotation of the key washer relative to the locking nut; and
a retaining ring mounted in a channel in the key washer, and extending into a groove in the seal runner.

10. The gas turbine engine as set forth in claim 9, wherein the locking nut and the seal runner are threadably secured to the shaft.

11. The gas turbine engine as set forth in claim 10, wherein the groove in the seal runner is formed on a plurality of circumferentially spaced tabs on an outer periphery of the seal runner flange.

12. The gas turbine engine as set forth in claim 11, wherein the retaining ring has a plurality of ring slots to allow passage of the tabs on the seal runner when the retaining ring is mounted onto the seal runner, with the retaining ring then being turned such that the ring slots are no longer aligned with the seal runner tabs.

13. The gas turbine engine as set forth in claim 9, wherein the groove in the seal runner is formed on a plurality of circumferentially spaced tabs on an outer periphery of the seal runner flange.

14. The gas turbine engine as set forth in claim 9, wherein the retaining ring has at least one ring serration at an outer periphery, and the groove having key washer serrations such that the at least one retaining ring serration lock the retaining ring relative to the groove.

15. The gas turbine engine as set forth in claim 9, wherein the retaining ring has a plurality of ring slots to allow passage of the tabs on the seal runner when the retaining ring is mounted onto the seal runner, with the retaining ring then being turned such that the ring slots are no longer aligned with the seal runner tabs.

16. A method of assembling a seal runner to a rotating shaft comprising the steps of:
providing a shaft, and mounting a locking nut to an outer peripheral surface on the shaft, and mounting a seal runner at an inner peripheral surface of the shaft to form an initial assembly, the seal runner having a flange axially beyond the shaft for providing a sealing surface with a seal assembly;
mounting a retaining ring within a key washer, and moving a subassembly of the key washer and retaining ring onto the initial assembly, with anti-rotation structure formed to prevent rotation of the key washer relative to the locking nut, and with slots in both the key washer and the retaining ring allowing passage of seal runner tabs on the seal runner to pass; and
then turning the retaining ring such that the ring slots are no longer aligned with the seal runner tabs and such that the seal runner is retained.

17. The method as set forth in claim 16, wherein the locking nut and the seal runner are threadably secured to the shaft.

18. The method as set forth in claim 16, wherein seal runner grooves are formed at a plurality of circumferentially spaced tabs on an outer periphery of the seal runner flange.

19. The method as set forth in claim 16, wherein the retaining ring has at least one ring serration, and there being a plurality of key washer serrations in the key washer, and wherein the step of turning the retaining ring has the at least one retaining ring serration moving along the plurality of key washer serrations to lock the retaining ring.

20. The method as set forth in claim 16, wherein the retaining ring has spaced ends that are brought together to mount the retaining ring to the key washer.
